(19) United States
(12) Patent Application Publication
(10) Pub. No.: US 2020/0027073 A1
(43) Pub. Date: Jan. 23, 2020

(54) TIME-SENSITIVE DATA TAGGING

(71) Applicant: Bank of America Corporation, Charlotte, NC (US)

(72) Inventors: Ramandeep Sohal, Plano, TX (US); Megha Kumar, Richardson, TX (US); Soujanya Sattireddy Medapati, Frisco, TX (US); Peter E.C. Olson, Plano, TX (US); Xin Xiao, Frisco, TX (US)

(21) Appl. No.: 16/041,134

(22) Filed: Jul. 20, 2018

(51) Int. Cl. G06Q 20/24; G06Q 20/34

(52) U.S. Cl. CPC G06Q 20/24; G06Q 20/34

(57) ABSTRACT

A system for tagging transactions is disclosed. The system receives a tagging notice for tagging transactions that will occur within a future time window. The tagging notice includes a notification to create a transaction tag and a pre-determined time window associated with the transaction tag. In response to the tagging notice, the system creates the transaction tag. When receiving new transactions after creating the transaction tag, the system compares a timestamp of the new transaction to the pre-determined time window specified in the tagging notice. If the timestamp of the new transaction falls within the pre-determined time window, the system associates the new transaction with the transaction tag.

### TECHNICAL FIELD

This disclosure relates generally to a system for performing data tagging, and more particularly to a system for processing time-sensitive data tagging.

### BACKGROUND

Many existing systems or applications have tagging features to tag data received over the network. However, the existing systems and application perform the data tagging in an after-the-fact manner. For example, an existing system may receive a significant number of data elements over the network and store the data elements in a database. To add or associate tags to the data elements, the system may access the database, inspect each of the data elements, and determine an existing tag to associate with the data elements or create a new tag to associate with the data elements. The system may also need to determine whether there is a need to modify a tag associated with a data element. However, these operations, such as accessing the database, inspecting the data elements, associating tags to the data elements, and modifying tags of the data element, require frequent accesses to the database that stores the data elements and tags. For example, the system may send a significant number of web queries over the network to the database for performing these operations. This may create a network strain and lead to a network bottleneck.

Furthermore, the operations as mentioned above, such as accessing the database, inspecting the data elements, associating tags to the data elements, and modifying tags of the data element, require frequent read and write operations to the memory of a computer that implements the existing systems or applications. The frequent read and write operations to the memory places a burden on the memory space of the computer so that the computer is unable to make the memory space available for processing other tasks that also require usage of the memory space. This would significantly slow the processing speed and lower the processing efficiency of the computer that implements the existing systems or applications.

### SUMMARY

Many existing systems or applications have tagging features to tag data received over the network. However, the existing systems and applications perform the data tagging in an after-the-filet manner. An existing system may receive a significant number of data elements (e.g., transactions) over the network and store the data elements in a database. To add or associate tags to the data elements, the system. may access the database, inspect each of the data elements, and determine an existing tag to associate with the data elements or create a new tag to associate with the data elements. For example, the system may receive a request to add or associate a tag to transactions that are conducted within a certain period. The system may access a database that stores the transactions, examine each of the transactions, determine whether the timestamps of the transactions fall within a pre-defined period. However, these operations, such as accessing the database, examining each of the transactions, determining timestamps of the transactions, require frequent accesses to the database that stores the transactions. For example, the system may send a significant number of web queries over the network to the database for performing these operations relating to the transactions. This may create a network strain and lead to a network bottleneck.

The present disclosure discloses a system and method that creates a tag ahead. of time for tagging future transactions. Specifically, the disclosed system creates tags to tag transactions that will occur within a time window in the future. In this way, when receiving a new transaction, the disclosed system can immediately determine whether the new transaction occurs within a pre-defined time window for a pre-created tag, and if so, associate the new transaction with the pre-created tag. Then, the disclosed system may store the tagged transaction in the database. As opposed to the existing systems that tag transactions in an after-the-fact manner as noted before, the disclosed system associates the new transaction with the pre-created tag before storing it in the database. As such, the disclosed system avoids frequently accessing the database that stores the transactions to examine each of the transactions, determine timestamps, and associate tags to the transactions. Note that the database may store a significant number of transactions including old transactions that are not of interest. Examining each of the transactions in the database creates a significant strain on the network because the system needs to send a significant number of queries relating to various operations on the transactions to the database over the network. By avoiding frequently accessing the database, the disclosed system and method can significantly reduce the strain on the network and alleviate the network bottleneck. Furthermore, by avoiding frequently accessing the database, the disclosed system and method can significantly reduce the amount of read and write operations to the memory of a computer that implements the disclosed system, thereby reducing a burden on the memory space of the computer and improving the performance of the computer.

In one embodiment, the disclosed system receives, at a first time point, a first tagging notice tier tagging transactions that will occur within a future time window. The first tagging notice includes a notification to create a first transaction tag and a pre-determined time window associated with the first transaction tag. The pre-determined time window is later than the first time point. This means that the first transaction tag will be created to tag transactions that will occur within a future time window.

In response to the first tagging notice, the disclosed system creates the first transaction tag associated with the pre-determined time window. Then, the system receives a first transaction from a user at a second time point that is later than the first time point. The first transaction is associated with a first timestamp, a first user account of the, user (e.g., credit card account, checking account), and a first transaction category (e.g., travel, food).

Next, the system compares the first timestamp of the first transaction to the pre-determined time window specified in the first tagging notice. If the first, timestamp of the first transaction falls within the pre-determined time window, the disclosed system associates the first transaction with the first transaction tag.

The system further receives a second transaction from the user at a third time point that is also later than the first time point. The second transaction is associated with a second timestamp, a second user account of the user, and a second transaction category. The system compares the second timestamp of the second transaction to the pre-determined time window specified in the first tagging notice. If the second timestamp of the second transaction falls within the pre-determined time window, the disclosed system also associates the second transaction with the first transaction tag.

If the system receives any other transactions that occur within the pre-determined time window, the system also associates the transactions with the first transaction tag, regardless of their associated user accounts and transaction categories. The system may perform further operations on the transactions associated with the first transaction tag. For example, the system may calculate a sum of the transaction amount of each of the transactions associated with the first transaction tag.

As discussed in the above embodiment, the disclosed system pre-creates a tag for tagging transactions that will occur within a future time window. When the system receives a new transaction from a user, the system can determine whether to associate the new transaction with the pre-created tag. In this way, the disclosed system avoids frequently accessing the database that store the transactions and examining each of the transactions in the database at a later time. By avoiding frequently accessing the database, the disclosed system can significantly reduce the strain on the network and alleviate the network bottleneck. Furthermore, by avoiding frequently accessing the database, the disclosed system can significantly reduce the amount of read and write operations to the memory of a computer that implements the disclosed system, thereby reducing a burden on the memory space of the computer and improving the performance of the computer.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates an exemplary embodiment of a system for performing time-sensitive data tagging, according to the present disclosure;

FIG. 2 illustrates an exemplary embodiment of a table of transactions, according to the present disclosure;

FIG. 3 illustrates an exemplary embodiment of a graphical user interface displaying transactions with tags; and

FIG. 4 illustrates a flow chart presenting an exemplary embodiment of a method of performing time-sensitive data tagging, according to the present disclosure.

### DETAILED DESCRIPTION

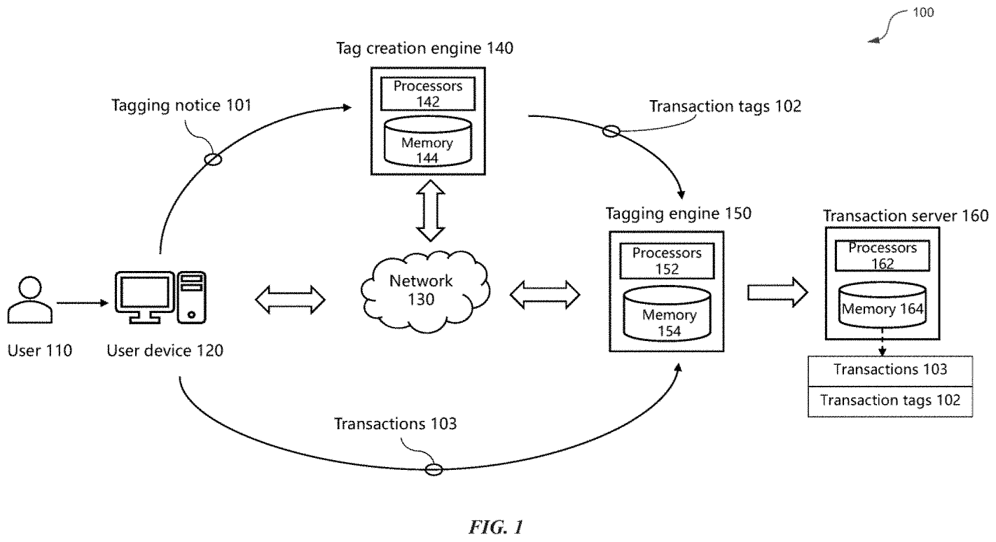

FIG. 1 illustrates an exemplary embodiment of a system 100 for performing time-sensitive data tagging, according to the present disclosure. System 100 includes one or more user devices 120, a network 130, a tag creation engine 140, a tagging engine 150, and a transaction server 160.

In general, system 100 receives a tagging notice 101 from a user 110 that operates on a user device 120. The tagging notice 101 includes a notification to create a transaction tag 102 and a pre-determined time window associated with the transaction tag 102. The transaction tag 102 will be used for tagging transactions 103 (e.g., database transactions, financial transactions, etc.) that will occur within the pre-determined time window in future. In response to the tagging notice 101, tag creation. engine 140 of system 100 creates the transaction tag 102 associated with the pre-determined time window. Then, the system 100 receives a new transaction 103 from the user 110. The new transaction 103 is associated with a timestamp 206, a transaction category 208 (e.g., travel, food), and a user account 210 (e.g., credit card. account, checking account) of the user 110. Next, the tagging engine 160 of system 100 compares the timestamp 206 of the new transaction 103 to the pre-determined time window specified in the tagging notice 101. If the timestamp 206 of the new transaction 103 falls within the pre-determined time window, tagging engine 150 associates the new transaction 103 with the transaction tag 102. System 100 further stores the new transaction 103 associated with the transaction tag 102 in the transaction server 160. If the timestamp 206 of the new transaction 103 does not fall within the pre-determined time window, tagging engine 150 determines not to associate the new transaction 103 with the transaction tag 102. System 100 further stores the new transaction 103 without the transaction tag 102 in the transaction server 160.

Users 110 comprise any -suitable users including businesses or other commercial organizations, government agencies, and/or individuals. Users 110 may operate on one or more user devices 120 to access system 100.

User devices 120 comprise any suitable devices or machines configured to communicate with other network devices in the system 100. Typically, user device 120 is a data processing system comprising hardware and software that communicates with the other network elements over a network, such as the Internet, an intranet, an extranet, a private network., or any other medium or link. These data processing systems typically include one or more processors, an operating system, one or more applications, and one or more utilities. Applications running on the data processing systems provide native support for web protocols including, but not limited to, support for Hypertext Transfer Protocol (HTTP), Hypertext Markup Language (HTML), and Extensible Markup Language (XML), among others. Examples of user devices 120 include, but are not limited to, desktop computers, mobile phones, tablet computers, and laptop computers.

Network 130 includes any suitable networks operable to support communication between components of system 100. Network 130 may include any type of wired or wireless communication channel capable of coupling together computing nodes. Network 130 may include any interconnecting system capable of transmitting audio, video, electrical signals, optical signals, data, messages, or any combination of the preceding. Network 130 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components of system 100. Network 130 may be configured to support any communication protocols as would be appreciated by one of ordinary skill in the art upon viewing this disclosure.

Tag creation engine 140 is a special purpose computer configured to create transactions tags 102, according to some embodiments of the present disclosure. Generally, tag creation engine 140 comprises one or more processors 142 and a memory 144 that implement the algorithm discussed herein. Specifically, tag creation engine 140 is configured to receive tagging notices 101 from users 110 that operate on devices 120 over the network 130. The tagging notice 101 includes a notification to create a transaction tag 102 and a pre-determined time window associated with the transaction tag 102. The pre-determined time window includes a starting date and an ending date. In alternative embodiments, the tagging notice 101 includes a notification to create a transaction tag 102 and a starting date for tagging transactions 103 that will occur after the starting date. The transaction tag 102 comprises any suitable type of tagging scheme, for example, such as a triple tag, a machine tag, a hash tag, a knowledge tag, or a free-form tag. In some embodiments, the transaction tag 102 comprises a hash tag. The transaction tag 102 will be used for tagging transactions 103 that will occur within the pre-determined time window specified in the tagging notice 101. For example, a user 110 may send a tagging notice 110 to the tag creation engine 140 requesting to create a hash tag (e.g., “#eurotrip”) for tagging transactions 103 that will occur during a future Europe trip.

In response to the tagging notice 101, the tag creation engine 140 of system 100 creates the transaction tag 102 associated with the pre-determined time window. The tag creation engine 140 may store the created transaction tags 102 in memory 144. The tag creation engine 140 may further send the created transaction tags 102 to the tagging engine 150 for further operations.

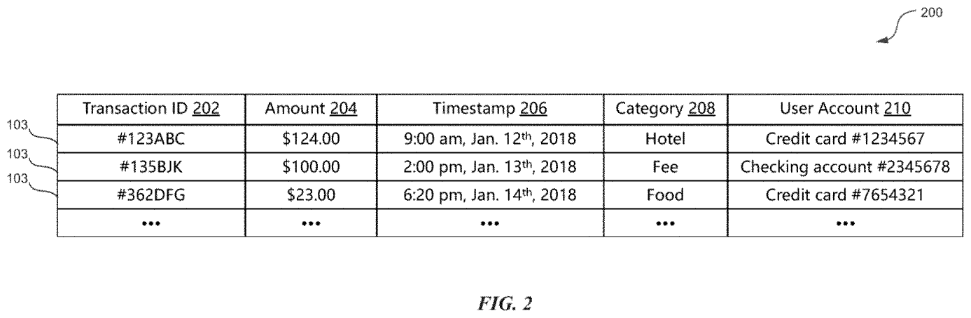

Tagging engine 150 of the system 100 is a special purpose computer configured to tag the transactions 103 with the transactions tags 102. Tagging engine 150 comprises one or more processors 162 and a memory 164 that implement the algorithm discussed herein. Tagging engine 150 may receive a transaction tag 102 from the tag creation engine 140 and identify the pre-determined time window associated with the transaction tag 102. Tagging engine 150 also receives transactions 103 from the users 110. FIG. 2 illustrates a table 200 that includes information for different transactions 103. For example, each transaction 103 is associated with a transaction ID 202, a transaction amount 204, a timestamp 206, a transaction category 208, and a user account 210.

Tagging engine 150 may compare the timestamps 206 of the transactions 103 with the pre-determined time window associated with the transactions tag 102, and determine whether the timestamps 206 are within the pre-determined time window. If the timestamps 206 are within the pre-determined time window, the tagging engine 150 associates the transactions 103 with the transaction tag 102. Note that transactions 103 with different transaction categories 208 and user accounts 210 may be tagged with the same transaction tag 102, if the timestamps 206 of the transactions 103 are alit within the pre-determined time window associated with the transaction tag 102. In some embodiments, the tagging engine 150 does not tag transactions 103 of recurring charges that occur within the pre-determined time window. Transactions 103 of recurring charges do not reflect an event that specifically occurs during the pre-determined time window. For example, during a trip to Europe, a user 110 may pay a monthly bill of a cable service. The cable service has nothing to do with the trip to Europe and is not incurred by an expense for the trip. Therefore, tagging a payment for the cable service with a transaction tag 102 for the trip is unnecessary.

In alternative embodiments, the tagging engine 150 may receive a transaction tag 102 from the tag creation engine 140 and identify only a starting date associated with the transaction tag 102. This means that the transaction tag 102 is created based on a tagging notice 101 that species only the starting date instead of a time window. In this case, the tagging engine 150 will tag all transactions 103 that will occur after the starting date. The tagging engine 150 may receive another tagging notice 101 later specifying an ending date for concluding tagging the transactions 103.

In alternative embodiments, after the tagging engine 150 receives a first transaction tag 102 with a first starting date and a first ending date, the tagging engine 150 may receive a second transaction tag 102 with a second starting date and a second ending date. The second starting date may be between the first starting date and the first ending date. In this case, the tagging engine 150 may stop tagging transactions 103 with the first transaction tag 102 at the second starting date and start tagging transactions 103 with the second transaction tag 102 at the second starting date.

Transaction server 160 includes any suitable storage scheme including any software, hardware, firmware, and/or combination thereof capable of storing information. Exemplary transaction server 160 includes individual data storage devices e.g., memory, disks, solid-state drives), which may be part of individual storage engines and/or may be separate entities coupled to storage engines. Transaction server 160 may store third-party databases, database management systems, a file system, and/or other entities that include or that manage data repositories. Transaction server 160 may be locally located or remotely located to other components of system 100.

Transaction server 160 is configured to aggregate and store the transactions 103 with and without the transaction tags 102. In some embodiments, as illustrated, transaction server 160 comprises one or more processors 162 and a memory 164 that implement the algorithm discussed herein. Transaction server 160 may receive the transactions 103 associated with the transaction tags 102 from the tagging engine 150. The transaction server 160 may store the transactions 103 associated with the transaction tags 102 in memory 164. The transaction server 150 may also receive the transactions 103 without the transaction tags 102 from the tagging engine 150. The transaction server may store the transactions 103 without the transaction tags 102 in memory 164.

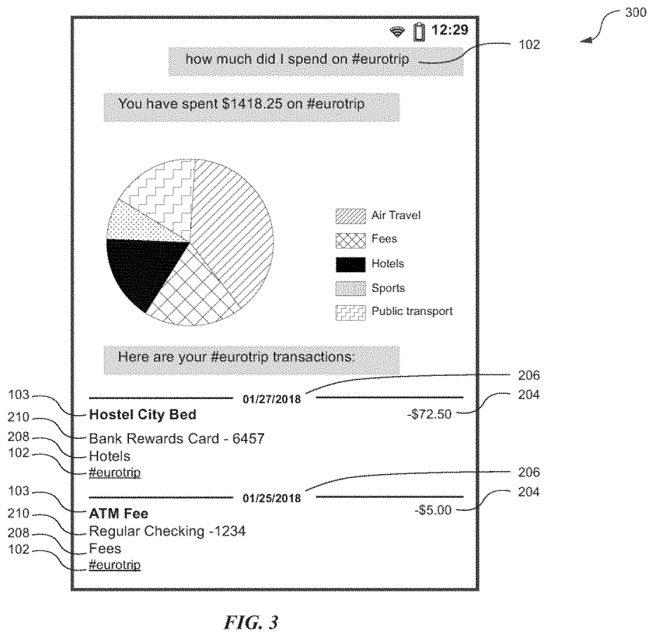

In some embodiments, the transaction server 160 generates a graphical user interface 300 to display the transactions 103 tagged with a transactions tag 102 as described below with reference to FIG. 3.

FIG. 3 illustrates an exemplary embodiment of a graphical user interface 300 displaying transactions 103 with transaction tags 102. As illustrated, a transaction tag 102 is pre-created as a hash tag “#eurotrip.” A first transaction 103 is associated with a first user account 210 (e.g., a credit card account) and a first transaction category 208 (e.g., “hotels”). A second transaction 103 is associated with a second user account 210 (e.g., a checking account) and a second transaction category 208 (e.g., “fees”). A first timestamp 206 of the first transaction 103 and a second timestamp 206 of the second transaction 103 are determined to be within a pre-determined time window associated with the transaction tag 102 “#eurotrip.” As illustrated, both the first and the second transactions 103 are tagged with the transaction tag 102 “#eurotrip.”

The tag creation engine 140, the tagging engine 150, and the transaction server together constitute a system 100 that creates transaction tags 102 ahead of time and. uses the transaction tags 102 for tagging future transactions 103. The system 100 in the present disclosure creates transaction tags 102 ahead of time for tagging future transactions 103. When receiving a new transaction 103, the disclosed system 100 can determine whether the new transaction 103 occurs within a pre-defined time window for a pre-created transaction tag 102, and if so, associate the new transaction. 103 with the pre-created transaction tag 102.

In this way, the disclosed system 100 avoids frequently accessing the database (e.g., transaction server 160) that store the transactions 103 and examining each of the transactions 103 in the database. By avoiding frequently accessing the transaction server 160, the disclosed system 100 can significantly reduce the strain on the network 130 and alleviate any network bottlenecks. Furthermore, by avoiding frequently accessing the transaction server 1.60, the disclosed system 100 can significantly reduce the amount of read and write operations to the memory space (e.g. memory 154 and 164) of a computer system that implements the disclosed system 100, thereby reducing a burden on the memory space of the system 100 and improving the performance of the computer system.

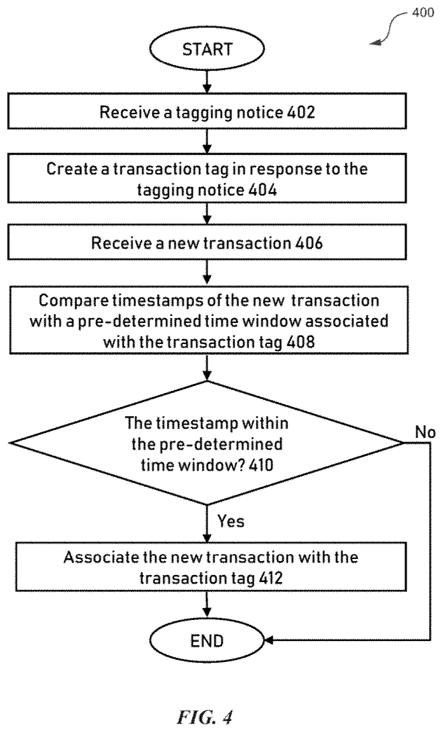

FIG. 4 illustrates a flow chart presenting an exemplary embodiment of a method 400 of performing time-sensitive data tagging, according to the present disclosure. The following is a non-limiting example that illustrates how system 100 implements method 400.

Upon starting the process, system 100 receives a tagging notice 101 from a user 110. The tagging notice 101 includes a notification to create a transaction tag 102 and a pre-determined time window associated with the transaction tag 102. The transaction tag 102 comprises any suitable type of tagging scheme. For example, the tagging notice 101 may include a notification to create a hash tag “#eurotrip” to tag the transactions 103 during a future trip to Europe. System 100 may receive multiple tagging notices 101 from the user 110 to tag transactions 103 during different time windows.

In alternative embodiments, the tagging notice 101 includes a notification to create a transaction tag 102 and a starting date associated with the transaction tag 102. This means that the transaction tag 102 will be created to tag all transactions 103 that will occur after the starting date. The system 100 may receive another tagging notice 101 later specifying an ending date for concluding tagging the transactions 103.

At step 404, in response to the tagging notice 101, system 100 creates the transaction tag 102 associated with the pre-determined time window. If there are multiple tagging notices 101, system 100 may create multiple transaction tags 102 associated with different time windows.

At step 406, the system 100 receives a new transaction 103 from the user 110. The new transaction 103 is associated with a timestamp 206, a transaction category 208 (e.g., travel, food), and a user account 210 (e.g., credit card account, checking account) of the user 110.

At step 408, the system 100 compares the timestamp 206 of the new transaction 103 to the pre-determined time window specified in the tagging notice 101. In alternative embodiments, if the tagging notice 101 specifies only a starting date for the transaction tag 102, the system 100 compares the timestamp 206 of the new transaction. 103 to the starting date.

At step 410, the system 100 determines whether the timestamp 206 of the new transaction 103 is within the pre-determined time window specified in the tagging notice 101. If the system 100 determines that the timestamp 206 of the new transaction. 103 is within the pre-determined time window, method 400 proceeds to step 412. If the system 100 determines that the timestamp 206 of the new transaction 103 is not within the pre-determined time window, system 100 may determine not to associate the new transaction 103 with the transaction tag 102 and store the new transaction 103 in transaction server 160.

In alternative embodiments, if the tagging notice 101 includes a notification to create a transaction tag 102 and a starting date associated with the transaction tag 102, the system 100 determines whether the timestamp 206 of the new transaction 103 is later than the starting date. If the system 100 determines that the timestamp 206 of the new transaction 103 is later than the starting date, method 400 proceeds to step 412. If the system 100 determines that the timestamp 206 of the new transaction 103 is earlier than the starting date, system. 100 may determine not to associate the new transaction 103 with the transaction tag 102 and store the new transaction 103 in transaction server 160.

At step 412, the system 100 associates the new transaction 103 with the transaction tag 102 in response to determining that the timestamp 206 of the new transaction 103 is within the pre-determined time window specified in the tagging notice 101.

The system 100 may perform additional steps that are not illustrated in. FIG. 4. For example, system 100 may perform another step to store the transactions 103 associated with the transaction tags 102 in the transaction server 160, The system 100 may perform another step to determine whether a time window specified for a second transaction tag 102 overlaps a time window specified for a previous transaction tag 102. If the system 100 determines there is an overlap, for example if the starting date specified for the second transaction tag 102 is between a starting date and an ending date specified for the previous transaction tag 102, the system 100 may perform another step to stop tagging transactions 103 with the previous transaction tag 102 at the starting date for the second transaction tag 102 and start tagging transactions 103 with the second transaction tag 102 at the starting date for the second transaction tag 102. The system 100 may perform another step to compute a total transaction amount for all transactions 103 associated with a transaction tag 102.

While several embodiments have been provided in the present disclosure, it should be understood that the disclosed systems and methods might be embodied in many other specific forms without departing from the spirit or scope of the present disclosure. The present examples are to be considered as illustrative and not. restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skill in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. §112(f) as it exists on the date of filing hereof unless the words “means for” or “step for” are explicitly used in the particular claim.

What is claimed is:

1. A system for tagging transactions, comprising:
a tag creation engine configured to:
receive, at a first time point, a first tagging notice, the first tagging notice comprising a notification to create a first transaction tag and a pre-determined time window associated with the first transaction tag, wherein the pre-determined time window is later than the first time point; and
in response to the first tagging notice, create the first transaction tag, the first transaction tag being associated with the pre-determined time window;
a tagging engine configured to:
receive, at a second time point, a first transaction associated with a user, the first transaction being associated with a first timestamp, a first user account of the user, and a first transaction category, wherein the second time point is later than the first time point;
compare the first timestamp of the first transaction to the pre-determined time window identified in the first tagging notice; and
in response to determining that the first timestamp is within the pre-determined time window, associate the first transaction with the first transaction tag;
receive, at a third time point, a second transaction associated with the user, the second transaction being associated with a second timestamp, a second user account of the user, and a second transaction category, wherein the third time point is later than the first time point;
compare the second timestamp of the second transaction to the pre-determined time window identified in the first tagging notice; and
in response to determining that the second timestamp is within the pre-determined time window, associate the second transaction with the first transaction tag;
a transaction server configured to:
store the first transaction associated with the first transaction tag; and
store the second transaction associated with the first transaction tag.

2. The system of claim 1, wherein the pre-determined time window of the first transaction tag identified in the first tagging notice comprises a starting date and an ending date.

3. The system of claim 2, wherein comparing the first timestamp of the first transaction to the pre-determined time window identified in the first tagging notice comprises:
comparing the first timestamp to the starting date and the ending date of the pre-determined time window; and
determining whether the first timestamp is between the starting date and the ending date.

4. The system of claim 1, wherein the first transaction tag comprises a hash tag.

5. The system of claim 1., wherein the first transaction and the second transaction are not recurring charges.

6. The system of claim 1, wherein the tagging engine is further configured to:
receive, at a fourth time point, a third transaction associated with the user, the third transaction being associated with a third timestamp, a third user account of the user, and a third transaction category, wherein the fourth time point is later than the first time point;
compare the third timestamp of the third transaction to the pre-determined. time window identified in the first tagging notice; and
in response to determining that the third timestamp is not within the pre-determined time window, determine not to associate the third transaction with the first transaction tag.

7. The system of claim 6, wherein the transaction server is further configured to store the third transaction.

8. The system of claim 1, wherein a user account comprises one of the following:
a credit card account;
a checking account; or
a saving account.

9. A non-transitory computer-readable medium comprising a logic for tagging transactions, the logic, when executed by one or more processors, instructing the one or more processors to:
receive, at a first time point, a first tagging notice, the first tagging notice comprising a notification to create a first transaction tag and a pre-determined time window associated with the first transaction tag, wherein the pre-determined time window is later than the first time point;
in response to the first tagging notice, create the first transaction tag, the first transaction tag being associated with the pre-determined time window;
receive, at a second time point, a first transaction associated with a user, the first transaction being associated with a first timestamp, a first user account of the user, and a first transaction category, wherein the second time point is later than the first time point;
compare the first timestamp of the first transaction to the pre-determined time window identified in the first tagging notice;
in response to determining that the first timestamp is within the pre-determined time window, associate the first transaction with the first transaction tag;
receive, at a third time point, a second transaction associated with the user, the second transaction being associated with a second timestamp, a second user account of the user, and a second transaction category, wherein the third time point is later than the first time point;
compare the second timestamp of the second transaction to the pre-determined time window identified in the first tagging notice;
in response to determining that the second timestamp is within the pre-determined time window, associate the second transaction with the first transaction tag;
store the first transaction associated with the first transaction tag; and
store the second transaction associated with the first transaction tag.

10. The non-transitory computer-readable medium of claim 9, wherein the pre-determined time window of the first transaction tag identified in the first tagging notice comprises a starting date and an ending date.

11. The non-transitory computer-readable medium of claim 10, wherein comparing the first timestamp of the first transaction to the pre-determined time window identified in the first tagging notice comprises:
comparing the first timestamp to the starting date and the ending date of the pre-determined time window; and
determining whether the first timestamp is between the starting date and the ending dates.

12. The non-transitory computer-readable medium of Claim. 9, wherein the first transaction tag comprises a hash tag.

13. The non-transitory computer-readable medium of claim 9, wherein the first transaction and the second transaction are not recurring charges.

14. The non-transitory computer-readable medium of claim 9, wherein the logic, when executed by one or more processors, further instructs the one or more processors to:
receive, at a fourth time point, a third transaction associated with the user, the third transaction being associated with a third timestamp, a third user account of the user, and a third transaction category, wherein the fourth time point is later than the first time point;
compare the third timestamp of the third transaction to the pre-determined time window identified in the first tagging notice; and
in response to determining that the third timestamp is not within the pre-determined time window, determine not to associate the third transaction with the first transaction tag.

15. A method for tagging transactions, comprising:
receiving, at a first time point, a first tagging notice, the, first tagging notice comprising a notification to create a first transaction tag and a pre-determined time window associated with the first transaction tag, wherein the pre-determined time window is later than the first time point;
in response to the first tagging notice, creating the first transaction tag, the first transaction tag being associated with the pre-determined time window;
receiving, at a second time point, a first transaction associated with a user, the first transaction being associated with a first timestamp, a first user account of the user, and a first transaction category, wherein the second time point is later than the first time point;
comparing the first timestamp of the first transaction to the pre-determined time window identified in the first tagging notice;
in response to determining that the first timestamp is within the pre-determined time window, associating the first transaction with the first transaction tag;
receiving, at a third time point, a second transaction associated with the user, the second transaction being associated with a second timestamp, a second user account of the user, and a second transaction category, wherein the third time point is later than the first time point;
comparing the second timestamp of the second transaction to the pre-determined time window identified in the first tagging notice;
in response to determining that the second timestamp is within the pre-determined time window, associating the second transaction with the first transaction tag;
storing the first transaction associated with the first transaction tag; and
storing the second transaction associated with the first transaction tag.

16. The method of claim 15, wherein the pre-determined time window of the first transaction tag identified in the first tagging notice comprises a starting date and an ending date.

17. The method of claim 16, wherein comparing the first timestamp of the first transaction to the pre-determined time window identified in the first tagging notice comprises:
comparing the first timestamp to the starting date and the ending date of the pre-determined time window; and
determining whether the first timestamp is between the starting date and the ending dates.

18. The method of claim 15, wherein the first transaction tag comprises a hash tag.

19. The method of claim 15, wherein the first transaction and the second transaction are not recurring charges.

20. The method of claim 15, wherein the method further comprises:
receiving, at a fourth time point, a third transaction associated with the user, the third transaction being associated with a third timestamp, a third user account of the user, and a third transaction category, wherein the fourth time point is later than the first time point;
comparing the third timestamp of the third transaction to the pre-determined. time window identified in the first tagging notice; and
in response to determining that the third timestamp is not within the pre-determined time window, determining not to associate the third transaction with the first transaction tag.
